(19) United States
(12) Patent Application Publication
(10) Pub. No.: US 2014/0157930 A1
(43) Pub. Date: Jun. 12, 2014

(54) ACTIVATION ARRANGEMENT FOR AN AUTOMATIC MOTOR VEHICLE TRANSMISSION AND FOR A BRAKE DEVICE AND A METHOD FOR ACTIVATING SUCH AN ACTIVATION ARRANGEMENT

(71) Applicant: Dr. Ing. h.c. F. Porsche Aktiengesellschaft, Stuttgart (DE)

(72) Inventors: Peter Schneider, Simmozheim (DE); Volker Gaertner, Bietigheim Bissingen (DE); Dominik Bender, Stuttgart (DE); Marco Pfeifer, Neuhausen a.F. (DE)

(73) Assignee: Dr. Ing. h.c. F. Porsche Aktiengesellschaft, Stuttgart (DE)

(21) Appl. No.: 14/078,590

(22) Filed: Nov. 13, 2013

(30) Foreign Application Priority Data
Dec. 12, 2012 (DE) 102012112144.3

(51) Int. Cl. F16H 59/10

(52) U.S. Cl. CPC F16H 59/105
USPC 74/473.3

(57) ABSTRACT

An activation arrangement for both an automatic motor vehicle transmission and for a parking brake includes a transmission selector device for selecting different drive positions and a momentary contact switch device for actuating the parking brake. The momentary contact switch device including a push-push momentary contact switch.

### CROSS REFERENCE TO RELATED APPLICATIONS

This application claims priority from German Patent Application No. 10 2012 112 144.3, filed Dec. 12, 2012, which is hereby incorporated by reference herein in its entirety.

### FIELD

The invention relates to an activation arrangement for an automatic motor vehicle transmission and for a parking brake having a transmission selector device for selecting different drive positions and having a momentary contact switch device for actuating a parking brake as well as to a method for activating such an activation arrangement.

### BACKGROUND

Such an activation arrangement is known, for example, from DE 10 2007 036 423 A1. This activation arrangement has a shift lever by means of which the transmission stages for idling, continuous driving mode and reversing as well as the parking lock which acts on the transmission can be set in a conventional manner. Furthermore, a display element is also embodied as a push button key, with the result that the parking brake system can be activated by means of this push button key. Although such an activation arrangement and such a method for activating such an activation arrangement function sufficiently adequately, the expenditure on control technology and circuitry is still very high.

### SUMMARY

In an embodiment, the present invention provides an activation arrangement for both an automatic motor vehicle transmission and for a parking brake includes a transmission selector device for selecting different drive positions and a momentary contact switch device for actuating the parking brake. The momentary contact switch device including a push-push momentary contact switch.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a perspective view of a front part of the passage compartment of a motor vehicle;

FIG. 2 shows a perspective view of an activation arrangement according to the invention in detail, and

FIG. 3 shows a schematic flow chart of a method for activating such an activation arrangement.

### DETAILED DESCRIPTION

An aspect of the invention is to make available a simplified activation arrangement for an automatic motor vehicle transmission and for a brake device, and this correspondingly also requires a simplified method for activating such an activation arrangement.

In an embodiment, the present invention provides a momentary contact switch device that is embodied as a push-push momentary contact switch. In this way it is possible to ensure a parked position of the motor vehicle in a way which is very easy in terms of control technology. In one particularly advantageous embodiment, the transmission selector device is embodied as a monostable selector lever for selecting a transmission setting/range comprising idling (N), continuous driving mode (D) and reverse (R). As a result it is possible to select the desired status by simply tapping the selector lever in the direction of the transmission range or transmission setting characterized, for example, by transparent letters. After the tapping, the selector lever always returns to its home position (monostable position). In this context, it is particularly advantageous if a lighting device is provided for the symbols N, R, D of the transmission selector device and for a symbol P of the push-push momentary contact switch. In this context, it is then particularly advantageous if the lighting device provides a functional lighting system such that the symbol N, R, D, (P) which is respectively assigned to a selected transmission setting/range or parked position is illuminated. In this context, it is also conceivable that the push-push momentary contact switch is continuously illuminated, wherein different colors are provided for an active status and an inactive status.

In addition, it is advantageous if both the locating lighting system and the functional lighting system of the operator control elements or the symbols can be dimmed. The dimming signal may be read in here by the bus system of the vehicle so that this lighting system can be adapted to the interior lighting of the rest of the vehicle and/or the ambient brightness. The dimming characteristic curves stored in the system can be embodied logarithmically or linearly. Advantageously in the case of ignition OFF, the lighting actuation can also be carried out by means of a fixed line.

The use of a double coil spring contact system in the push-push momentary contact switch has the advantage that no undefined momentary contact switch positions occur and the operator control request can be evaluated unambiguously.

With an embodiment according to the invention, the operator is provided directly with visual and/or acoustic feedback when the push-push momentary contact switch is activated, and is informed immediately about the status of the securing of the vehicle.

The system of activating the parking brake is advantageously embodied in a doubly redundant fashion and is continuously diagnosed. This diagnosis is carried out both for the lighting system and for the power supply. In the case of a fault, the driver can be informed via a display in the combination instrument.

Particularly valuable haptics of the push-push momentary contact switch are ensured by virtue of the fact that the push-push momentary contact switch has a PVD coating on a galvanic basis.

Furthermore, a brake control device can be provided which makes available a parking status message when a functional signal is present.

In an embodiment the present invention provides a method for activating an activation arrangement wherein, when the push-push momentary contact switch is engaged, a “close” functional signal is transmitted to the brake control device, and the selector lever control device subsequently performs status checking of the parking brake and releases the parking brake when the push-push momentary contact switch is disengaged in the case of a “parking brake on” status. In the case of a “parking brake off” status, the parking brake is closed. In this context, it is particularly advantageous if the selector lever control device can also take into account further states such as, for example, the signal of a charging plug.

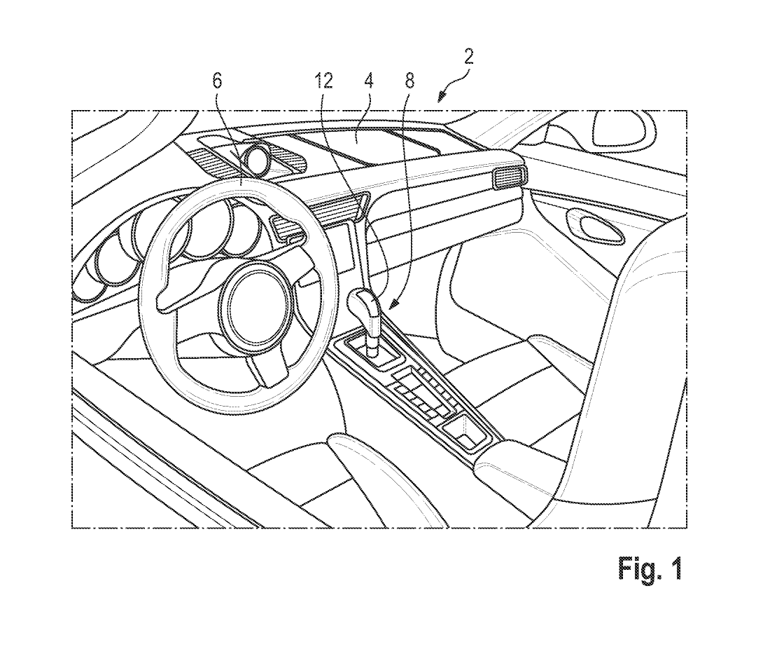

FIG. 1 shows a classic front part of the passenger compartment 2 of a motor vehicle. In a known fashion, the passenger compartment 2 has a dashboard 4, a steering wheel 6 and an activation arrangement 8.

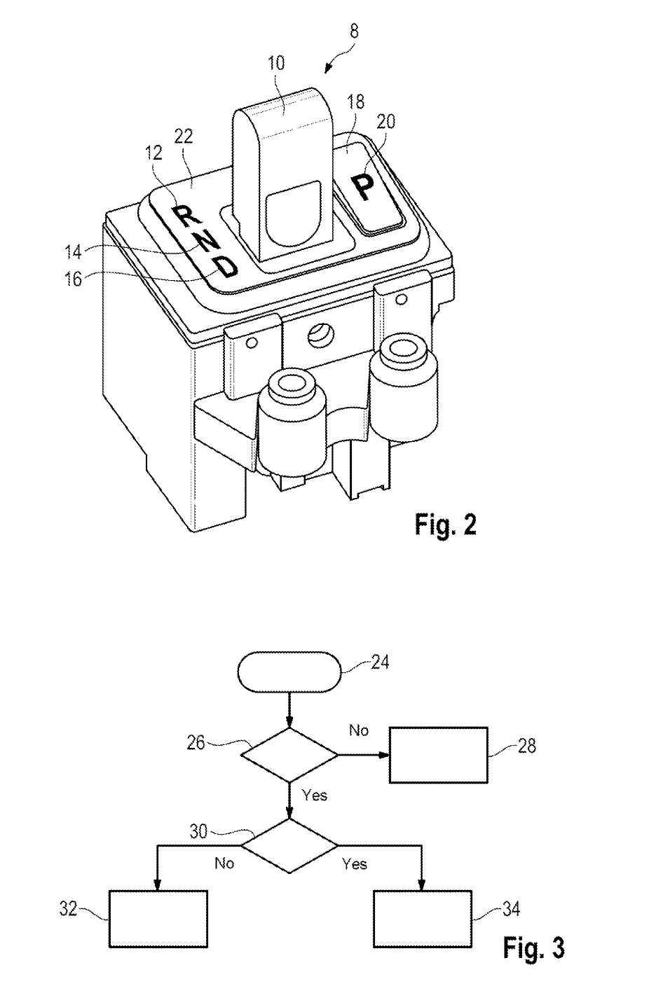

FIG. 2 then shows an inventive activation arrangement 8 from FIG. 1, in a perspective view and in detail. The activation arrangement 8 has substantially a transmission selector device 10 which is embodied as a selector lever in the present exemplary embodiment. For the sake of clarity, a knob 12 which is known per se and is illustrated in FIG. 1 is omitted from the illustration. The activation arrangement 8, which serves to actuate an automatic motor vehicle transmission (not illustrated further) and a parking brake (not illustrated further), permits different transmission stages to be selected and the parking brake to be actuated. The transmission stages include in the present exemplary embodiment the transmission settings comprising idling (N) and reversing mode (R) as well as the transmission setting range (D). These possible settings of the motor vehicle transmission are characterized by the symbols R 12, N 14 and D 16. Furthermore, a momentary switch device which is embodied as a push-push momentary contact switch 18 and which serves to actuate the parking brake is illustrated. The push-push momentary contact switch 18 has a symbol (P) 20. All the symbols R 12, N 14, D 16 and P 20 are embodied in a transparent form in the present exemplary embodiment and can be illuminated by a lighting device (not illustrated further). In this context, the lighting device is embodied in such a way that in each case the activated transmission range or the activated transmission setting is illuminated, for example in the color red. The symbol (P) 20 is illuminated continuously in the present exemplary embodiment. In the activated state of the parking brake, for this purpose the symbol (P) 20 is illustrated in a red color, and in a non-activated state of the parking brake it is illuminated in a green color or else is simply left unilluminated. The push-push momentary contact switch 18 and a decorative surface 20 of the activation arrangement 8 have a PVD coating on a galvanic basis, which ensures a particularly valuable and wear-proof surface.

The selector lever 10 is embodied in a monostable fashion in the present exemplary embodiment, with the result that the different transmission stages R 12, N 14 and D 16 can be selected by simple tapping. In this context, there is provision in a control unit (not illustrated further) that the idling mode N is selected from the transmission setting range D or from the reversing mode R by a first tapping action and the desired transmission stage can then be selected by tapping into the second position.

Furthermore, a brake control device (not illustrated further) is provided which makes available the status of the parking brake and directly actuates the functional lighting when the brake is applied. This is also the case in the event of a fault. The symbols also all have a locating lighting system which is usually active only when the light is switched on and is actuated by means of an evaluation of the CAN signal.

FIG. 3 shows in schematic form a block diagram relating to the activation of the parking brake. As a result of the engagement of the push-push momentary contact switch 18, a “close” functional signal is sent to the brake control device, and this is characterized by the “reception functional signal” block 24. In a subsequent interrogation 26 it is checked whether, for example, the charging plug is plugged. If the interrogation 26 is responded to with NO, the charging plug is not plugged, and in an interrogation 30 in the selector lever control device it is checked whether the signal of the parking brake the status message “parking brake off” is present. If this interrogation 30 is responded to with “No”, the parking brake is activated, as is characterized by the step 32 in FIG. 3. If the interrogation 30 is responded to with “Yes”, the status “parking brake on” is present and the parking brake is not disengaged.

If the interrogation 26 is responded to with YES and the transmission setting N is present, in an interrogation 30 it is checked in the selector control device whether the signal of the parking brake the status message “parking brake off” is present. If this interrogation 30 is responded to with “No” the parking brake is activated, as is characterized by the step 32 in FIG. 3. If the interrogation 30 is responded to with “Yes”, the status “parking brake on” is then present and the parking brake is released, as is illustrated by means of step 34.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1: An activation arrangement for an automatic motor vehicle transmission and for a parking brake, the activation arrangement comprising:
a transmission selector device for selecting different drive positions; and
a momentary contact switch device for actuating the parking brake, the momentary contact switch device including a push-push momentary contact switch.

2: The activation arrangement recited in claim 1, wherein the momentary contact switch device includes an arrangement for visual feedback.

3: The activation arrangement as recited in claim 1, wherein the transmission selector device includes a monostable selector lever for selecting a transmission setting/range comprising idling, continuous driving mode and reversing mode.

4: The activation arrangement as recited in claim 1, further comprising at least one lighting device corresponding to symbols N, R, and D associated with the transmission selector device, and a further lighting device corresponding to a symbol P of the push-push momentary contact switch.

5: The activation arrangement as recited in claim 4, wherein the at least one lighting device provides a locating and functional lighting such that the symbol N , R, D and P, which is respectively assigned to a selected transmission setting/range or parking position is illuminated.

6: The activation arrangement as recited in claim 1, wherein the push-push momentary contact switch is configured to be continuously illuminated and different colors are provided for visual feedback for an active status and an inactive status.

7: The activation arrangement as recited in claim 1, wherein a brake control device is provided which brings about a parking status message.

8: A method for activating an activation arrangement including a transmission selector device for selecting different drive positions, and a momentary contact switch device for actuating the parking brake that includes a push-push momentary contact switch, the method comprising:
transmitting, when the push-push momentary contact switch is engaged, a “close” functional signal to a brake control device, the brake control device subsequently performing a status check of a parking brake using a selector control device and releases the parking brake when the push-push momentary contact switch is disengaged in the case of a “parking brake on” status, and carries out a closing instruction and secures the vehicle in the case of a “parking brake off” status.

9: The method for activating an activation arrangement as recited in claim 8, wherein the push-push momentary contact switch is activated only if a charge plug status was not plugged in.
